(19) United States
(12) Patent Application Publication
(10) Pub. No.: US 2004/0017046 A1
(43) Pub. Date: Jan. 29, 2004

(54) Transmission joint boot

(76) Inventors: Richard D. Frazer, Berkley, MI (US); Toshitaka Asai, Utica, MI (US)

Correspondence Address: GKN AUTOMOTIVE, INC., 3300 University Drive, Auburn Hills, MI, 48326, US

(21) Appl. No.: 09/755,798

(22) Filed: Jan. 5, 2001

(51) Int. Cl. F16J 15/38

(52) U.S. Cl. 277/391

(57) ABSTRACT

A constant velocity joint boot for use with a constant velocity joint and an interconnecting shaft comprising a body portion having a central inner cavity defined by an inner wall, the inner cavity having a circumference smaller than the circumference of the interconnecting shaft, an outer wall defining at least one convolute, the body portion also including a first end having a mating surface contacting the constant velocity joint and a second end disposed opposite the first end and contacting the interconnecting shaft, wherein the body portion is manufactured from a foam based material.

### TECHNICAL FIELD

This invention relates to a transmission joint sealing boot for use with a transmission joint and, more particularly, to a constant velocity joint sealing boot for use with a constant velocity universal joint.

### BACKGROUND ART

Constant velocity universal joints, as one type of transmission joint, require sufficient lubrication to operate effectively. This lubrication is often provided in the form of a lubrication grease. This lubricating grease is contained around and within the constant velocity universal joint's operating parts. In this manner, transmission joint or constant velocity joint sealing boots of the kind commonly known in the industry frequently comprise a section for attachment to the transmission or constant velocity joint member, a second section for attachment to the bar shaft or other component. The transmission joint boot often includes a convoluted section that is disposed between the two sections to accommodate the angular movement of the joint in operation.

Certain boot designs have been developed to accommodate different applications of different constant velocity universal joints. In particular, high speed propeller shaft applications often require specific boot designs that can accommodate the relatively high revolutions per minute (rpms) generated by the propeller shaft. These boot designs include a convoluted boot section attached directly to the transmission or bar shaft and a second section attached to the outer race section of the constant velocity universal joint. As this design includes an intricate shape, the boot is often made of a soft neoprene or rubber. In side shaft or half shaft applications, where a constant velocity joint boot is used, the boot may be manufactured from thermoplastic elastomers or TPE's.

U.S. Pat. No. 5,833,542 assigned to applicant discloses a transmission joint sealing boot comprising a flexible diaphragm member having a passageway extending therethrough. The boot includes a first end defining an opening, an annular second end disposed opposite the first end and a flexible arcuate section connecting the first end and the annular second end of the flexible diaphragm member. The boot is manufactured from a thermoplastic elastomer.

U.S. Pat. No. 3,807,195 discloses a seal arrangement for a torque-transmitting joint comprising a boot with a large diameter end secured to a first joint member and a smaller diameter end secured to a second joint member. The boot including a curved portion adjacent the large diameter end is supported against the inner surface of the first joint member by an elastic retaining ring. In this arrangement, as disclosed, a plastic retaining ring is vulcanized to the cylindrical outer surface of the boot. The plastic retaining ring also engages on its opposite side, the peripheral surface of the axially extending section of the rigid holder.

New constant velocity joint improvements and designs require the advent of new transmission joint sealing boots having an improvement in performance in hot, cold, spin, fatigue sealing and squeak parameters.

### DISCLOSURE OF INVENTION

It is the principal object of the present invention to provide a transmission joint sealing boot manufactured from a foam based material to provide improvements in performance parameters.

It is another object of the present invention to provide a transmission joint sealing boot manufactured from a foam based material to provide improvements in performance parameters such as performance in heated conditions, performance in cold conditions, spin, fatigue, sealing and noise conditions.

It is still another object of the present invention to provide a transmission joint sealing boot and specifically a constant velocity joint boot manufactured from a silicone foam based material where sealing is achieved by using the boot material itself to seal.

It is yet another object of the present invention to provide a constant velocity joint boot which uses a high compressibility factor of the boot material to provide better sealing characteristics.

It is still yet another object of the present invention to provide a constant velocity joint boot which uses a closed cell foam based construction.

It is yet still another object of the present invention to provide a constant velocity joint boot which is a molded foam based construction.

In carrying out the above objects, there is provided a transmission joint sealing boot for use with a transmission joint comprising a body portion having a central inner cavity defined by an inner wall, a first end having a mating surface connecting with the transmission joint and a second end disposed opposite the first end wherein the body portion is manufactured from a foam based material.

In carrying out a more specific object of the invention there is further provided a constant velocity joint boot for use with a constant velocity joint and an interconnecting shaft, the boot comprising a body portion having a central inner cavity defined by an inner wall, said inner cavity having a circumference smaller than the circumference of said interconnecting shaft, an outer wall defining at least one convolute, said body portion also including a first end having a mating surface contacting the constant velocity joint and a second end disposed opposite said first end and contacting said interconnecting shaft, wherein said body portion is manufactured from a foam based material.

It is a further object of the present invention to provide a transmission joint sealing boot including a first end mating surface with a cage section which is shaped to mate with the cage of the transmission joint and a outer race section which is shaped to mate with the outer race of the transmission joint.

It is a further object of the present invention to provide a transmission joint sealing boot wherein the foam based material has a density in a range from 10 kg/m³ to 27 kg/m³.

These and other objects, features, and advantages of the present invention will become more readily apparent by reference to the following description of the drawings wherein like reference numerals correspond to like components.

### BRIEF DESCRIPTION OF DRAWINGS

FIG. 1 is a cross sectional view of the transmission joint sealing boot of the present invention attached to a high speed constant velocity joint with the inner race at an angle;

FIG. 2 is a cross sectional view of the transmission joint sealing boot of the present invention; and

FIG. 3 is a perspective view of the transmission joint sealing boot of the present invention.

### BEST MODE FOR CARRYING OUT THE INVENTION

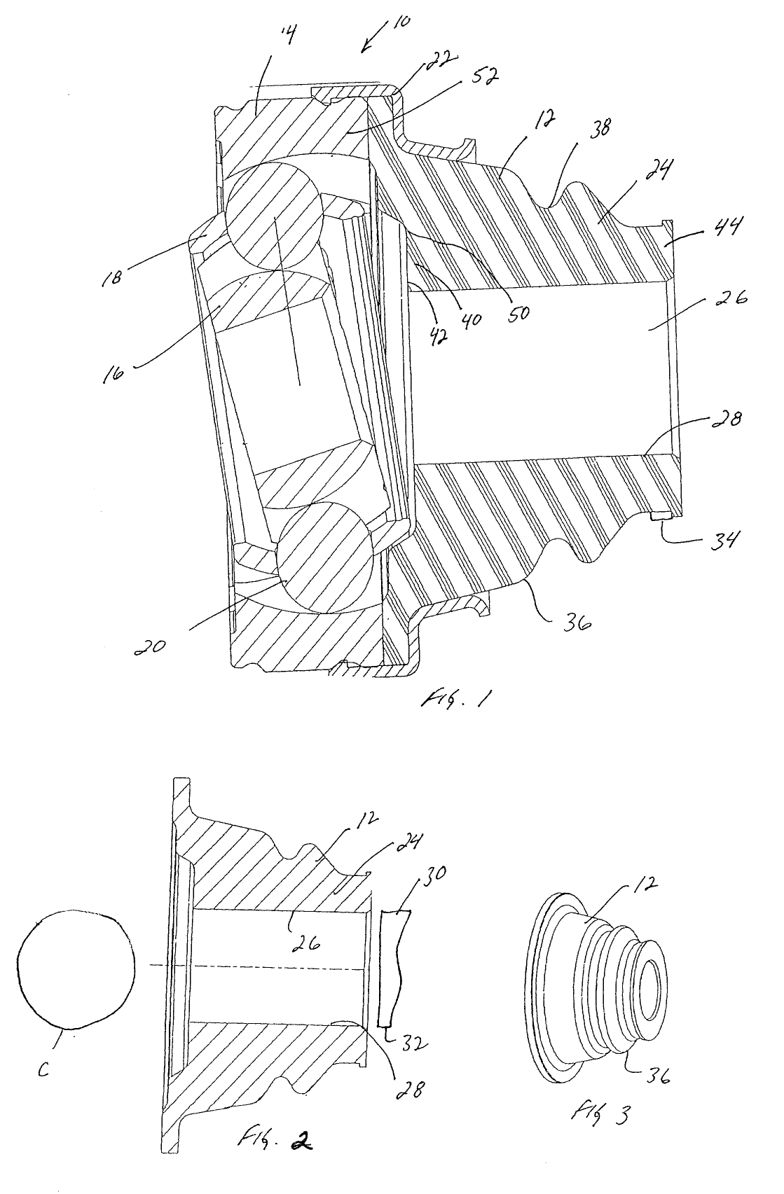

With reference to FIG. 1 of the drawings, there is shown a transmission joint 10 and a transmission joint sealing boot 12 of the present invention. Transmission joint 10 is more specifically, a constant velocity joint of the fixed type having an outer race 14 and an inner race 16. Transmission joint or constant velocity joint 10 also includes a cage 18 and a balls 20 as in known in the art. A connection can 22 is shown retaining the boot 12 onto the constant velocity joint 10. The present constant velocity joint as shown in FIG. 1 and described above is used for illustrative purposes only and the use of various other types of transmission and constant velocity joints for example, rzeppa type, fixed, plunging, tripod, sheet metal and cross groove joints is contemplated by the present invention. The present invention is capable of use with any style joint which requires use of a sealing boot. The inner race 16 and cage 18 are shown at angle to illustrate the freedom of movement of the joint in relation to the boot 12.

The transmission joint sealing boot or constant velocity joint boot 12 of the present invention is defined by a body portion 24 having a central inner cavity 26. Referring to FIG. 2, the central inner cavity 26 is defined by an inner wall 28. In the best mode, the inner cavity 26 has a circumference C smaller than the circumference of the interconnecting shaft 30 to provide an interference fit, or connection. The circumference in this embodiment is such that the interference fit is so tight, or the compression so adequate, that the need for clamp 34 is eliminated. In this fashion the boot 12 fits over and rests on the outer surface 32 of the interconnecting shaft 30. The present invention contemplates other embodiments having a circumference C which is the same circumference of the interconnecting shaft 30. In other standard embodiments a clamp 34 may be used as shown in FIG. 1 to seal the boot 12.

The outer wall 36 of the boot 12 defines at least one convolute 38 for use in articulation of the boot when the constant velocity joint is at angle. The body portion 24 also includes a first end 40 having a mating surface 42 contacting the constant velocity joint 10. A second end 44 is disposed opposite the first end 40 and contacts the interconnecting shaft 30. First end mating surface 42 includes a cage section 50 which is shaped to mate with cage 18 of constant velocity joint 10. The boot 12 also has an outer race section 52 which is shaped to mate with an outer race 14 of constant velocity joint 10. This mating connection provides the advantages such as sealing and assembly springback. The mating surface 42 and cage section 50 define a shape which allows complete freedom of movement of the inner race 16 and cage 18 as shown in FIG. 1.

The body portion 24 of the boot 12 is manufactured from a foam based material such as a closed cell silicone based molded foam. In the preferred embodiment, the foam based material has a closed cell construction. The foam based material has a density in a range from 10 kg/m³ to 27 kg/m³. The foam based material in the best mode, a heat resistance to 450° Fahrenheit.

The present invention provides advantages in that the total amount of grease required for the joint is reduced due to the body structure of the foam boot. This structure further eliminates the negative effect of centrifugal force applied to the grease. Grease is not pushed into any internal convolutes, as they do not exist in the present invention structure. Inner wall 28 defines a cylindrical shape which eliminates the internal convolutes of other prior art rubber boots.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A transmission joint sealing boot for use with a transmission joint, the transmission joint sealing boot comprising:
a body portion having a central inner cavity defined by an inner wall, a first end having a mating surface connecting with the transmission joint and a second end disposed opposite said first end wherein said body portion is manufactured from a foam based material.

2. A transmission joint sealing boot as in claim 1 wherein said foam based material is foam rubber.

3. A transmission joint sealing boot as in claim 1 wherein said foam based material is a closed cell material.

4. A transmission as in claim 1 wherein said foam based material is a closed cell silicone material.

5. A transmission joint sealing boot as in claim 1 wherein said first end mating surface includes a cage section which is shaped to mate with a cage of said transmission joint and an outer race section which is shaped to mate with an outer race of said transmission joint.

6. A transmission joint sealing boot as in claim 1 wherein said foam based material has a density in a range from 10 kg/m³ to 27 kg/m³.

7. A transmission joint sealing boot as in claim 1, wherein said foam based material is heat resistant to 450° Fahrenheit.

8. A constant velocity joint boot for use with a constant velocity joint and an interconnecting shaft, said constant velocity joint boot comprising:
a body portion having a central inner cavity defined by an inner wall, said inner cavity having a circumference smaller than the circumference of said interconnecting shaft, a first end having a mating surface contacting the constant velocity joint and a second end disposed opposite said first end and contacting said interconnecting shaft, wherein said body portion is manufactured from a foam based material.

9. A constant velocity joint boot as in claim 7 wherein said foam based material is foam rubber.

10. A constant velocity joint boot as in claim 7 wherein said foam based material is a closed cell material.

11. A constant velocity joint boot as in claim 7 wherein said foam based material is a closed cell silicone material.

12. A constant velocity joint boot as in claim 7 wherein said first end mating surface includes a cage section which is shaped to mate with a cage of said constant velocity joint and an outer race section which is shaped to mate with an outer race of said constant velocity joint.

13. A constant velocity joint boot as in claim 7 wherein said foam based material has a density in a range from 10 kg/m³ to 27 kg/m³.

14. A constant velocity joint boot as in claim 7, wherein said foam based material is heat resistant to 450° Fahrenheit.

15. A constant velocity joint boot for use with a constant velocity joint and an interconnecting shaft, said constant velocity joint boot comprising:
a body portion having a central inner cavity defined by an inner wall, said inner cavity having a circumference smaller than the circumference of said interconnecting shaft, an outer wall defining at least one convolute, said body portion also including a first end having a mating surface contacting the constant velocity joint and a second end disposed opposite said first end and contacting said interconnecting shaft, wherein said body portion is manufactured from a foam based material.

16. A constant velocity joint boot as in claim 15 wherein said foam based material is foam rubber.

17. A constant velocity joint boot as in claim 15 wherein said foam based material is a closed cell material.

18. A constant velocity joint boot as in claim 15 wherein said foam based material is a closed cell silicone material.

19. A constant velocity joint boot as in claim 15 wherein said first end mating surface includes a cage section which is shaped to mate with a cage of said constant velocity joint and an outer race section which is shaped to mate with an outer race of said constant velocity joint.

20. A constant velocity joint boot as in claim 15 wherein said foam based material has a density in a range from 10 kg/m³ to 27 kg/m³.

21. A constant velocity joint boot as in claim 15, wherein said foam based material is heat resistant to 450° Fahrenheit.
